(19) United States
(12) Patent Application Publication
(10) Pub. No.: US 2023/0002103 A1
(43) Pub. Date: Jan. 5, 2023

(54) LIDLESS CONTAINER AND METHOD FOR ASSEMBLING THE CONTAINER

(71) Applicant: COMPAGNIE GERVAIS DANONE, Paris (FR)

(72) Inventors: Alex James ORCHARD, Le Vesinet (FR); Valentina ANDREEVA-CHRAIBI, Sceaux (FR); Timothy James LLEWELLYN, London (GB)

(21) Appl. No.: 17/782,455

(22) PCT Filed: Dec. 3, 2020
(86) PCT No.: PCT/FR2020/052256

§ 371 Date: Jun. 3, 2022

(30) Foreign Application Priority Data
Dec. 4, 2019 (FR) 19 13727

(51) Int. Cl. B65D 3/20; B65D 3/06; B65D 3/26; B65B 3/02; B65B 3/04; B65B 7/18

(52) U.S. Cl. CPC B65D 3/20; B65D 3/06; B65D 3/26; B65B 3/027; B65B 3/04; B65B 7/18

(57) ABSTRACT

The container for product has a bottom wall and a lateral wall of tubular extension up to an annular and surrounding an opening for access to the inner volume. The container is of the type without cover or part that can be lost, including two distinct protrusions, projecting from the lateral wall in order to get a closed configuration, wherein the two protrusions are simultaneously: projecting opposite the bottom wall, from the annular end; and sealed to each other so as to form a sealing zone in order to hermetically close the opening. The container has two gripping portions, offset and distributed on the two protrusions and arranged outside of the sealing zone, which makes it quick to open. The container is recyclable, formed for example based on laminated paper or cardboard.

### FIELD OF THE INVENTION

The present invention relates to the field of conditioning packaging allowing a good conservation of the product that it contains, in particular dairy product remaining fresh, and more specifically the field of containers without a part that can be lost. The product may be solid at refrigeration temperature, semiliquid, liquid or in a viscous state, possibly in a form which makes retrieval/distribution thereof easy, where the product could optionally be consumed by means of a spoon, for example.

### BACKGROUND OF THE INVENTION

Containers having an integrated closure system, of the kind not separated from the lateral wall, are known. For example the document U.S. Pat. No. 6,164,488 describes a cup of paper or similar material which includes a flexible panel formed in the lateral wall thereof. The flexible panel is folded back for closing on top of the cup, leaving a narrow opening passage for drinking. However, for avoiding spells, these designs rely on the creation of a joint between the flexible panel and the inner wall against which it is butted. Because of this, the geometry and manufacturing of these types of cups prove complex, which limits the application thereof. The document GB 2,269,811 provides a similar arrangement for closing a container with a closure part integrated on one side of the lateral wall. A hinge effect allows the closure part (thinner than the facing butted region) to pass from an outwardly convex conformation, corresponding to the open state of the container, to an externally concave conformation corresponding to a state joined against a complementarity inner surface of the lateral wall. This type of container must however be plastic and also turns out to be relatively complex, in particular for getting a bistable property of the closure part, which limits the interest in this solution.

The document WO 01/26980 describes another configuration in which a plurality of tabs are fixed in a hinged way to the upper edge of the lateral wall of the container/cup. The tabs each have a generally trapezoidal shape with respective hook extensions which engage with each other around a straw when the tabs are folded even with the upper edge of the cup. The document DE1,052,305 B describes a container also provided with a closure that is complex to make; this container serves to contain a liquid such as milk.

However, closing this type of cup may prove problematic, for example, in the fast-food field where a large number of drinks are served in a relatively short time or even in the field of high-speed packaging of products requiring an easy closure operation. This is for example the case for containers that are filled and need to be refrigerated and transported to sales locations right away. It would also be desirable to improve the reliability of the sealing (hermetic) in order to assure that the content of the container remains intact, where the sealing needs to resist transportation stresses (in particular vibrations).

In that way, there is still a need for containers which, at least in the preferred embodiments, have integrally formed closure parts, but which remain relatively simple to produce and use.

### BRIEF SUMMARY OF THE INVENTION

In light of one or more of the observations laid out above, a container, intended for packaging a product is proposed comprising: a bottom, a lateral wall delimiting an interior volume, where the lateral wall extends upward (vertically, rising) from the bottom up to an annular end delimiting an opening for access to the interior volume;

where the container has a closed configuration and further comprises two distinct protrusions (or two ears) in order to get the closed configuration, in which the two protrusions are (in particular simultaneously):
projecting opposite the bottom, from the annular end of the lateral wall; and
sealed to each other so as to form a sealing zone in order to hermetically close the opening;
   where the container has two gripping portions, distributed on the two protrusions, where each of the gripping portions is arranged outside of the sealing zone.

Because of this construction, it is sufficient to separate the two protrusions from each other, by gripping the gripping portions. The use of the container remains simple. The manufacturing of the container may be simple and the sealing robust. In some embodiments, a spoon, a fork, a straw (if the product is sufficiently liquid), chopsticks, or picks may be used to retrieve the product through the opening. This design is further well suited to the use of paper or cardboard or laminates comprising a paper or cardboard layer, easy to recycle.

The protrusions result for example from a cutout and project upward before and after a tubular shaping of the lateral wall, where the lateral wall and protrusions are formed from a material in sheet form, preferably a single piece. The material in sheet form may be a paper or cardboard-based material, for example a laminate comprising at least one paper or cardboard layer and possibly one or more layers of metal and/or plastic and/or other materials improving the barrier properties. The material in sheet form may have the form of coils or precut units. The material for making the bottom may be identical to that for making the lateral wall and the protrusions. More generally, it is understood that the two protrusions that cannot be lost. After having emptied the container, the consumer may discard it as a single piece. This type of container is thus well suited for use on the move, since it can be transported in a backpack or various containers, which could be thermally insulated in case of a fresh product contained in the container, while limiting the risk of losing the cover or another part that could be lost.

In an embodiment, the container has an opening configuration (in an upright state), in which a first protrusion of the two protrusions remains projecting upward, opposite from the bottom, whereas all or part of the other or second protrusion is turned back or turned down on an exterior surface of the lateral wall. The container may therefore be placed on the base thereof on store shelves. As a variant, one of the protrusions may serve to form displays of containers supported by a support rod passing through an opening included in the protrusion, or again to assemble the containers in a group held together by a hoop, string or shared attachment element passing through this type of opening.

The bottom and the opening may each extend along a respective transverse plane preferably perpendicular to the lateral wall. The opening thus forms an access to the interior volume from the top, which for example allows holding the container vertically in the hand while consuming the product (while using as needed a spoon or other utensil for gathering up the product). It is understood that the container may minimize the parts to be discarded and keep the handling areas far away from the inner surfaces in contact with the product (surfaces located under the sealing zone, below the level of opening in practice).

Of course, the expression “the lateral wall extends upward (vertically) from the bottom” must be understood broadly, meaning that it is not necessary that the lateral wall be cylindrical: more generally it must be understood that the lateral wall has an overall vertical extension (where the wall could be flared upward by having a geometry which varies with the height of the wall).

The term “tubular” must be understood broadly when it describes the lateral wall, meaning that it is not necessary that the lateral wall have a symmetry of revolution: instead, here a tubular wall may designate a wall which extends from one narrower annular end and/or having one first fixed shape to another annular end, larger and/or having a second different geometric shape than the first geometric shape.

Typically, the two gripping portions are offset from each other. It is understood that the container is a quick open type. Advantageously, a simple action is sufficient to open it without tools. In variants, the performance of the action of separating the gripping portions may be conditional on unscrewing or withdrawing a safety element (removable and/or peelable).

It is for example intended that at least one of the two protrusions be a protrusion having or consisting of a flap towards the outside. Preferably, it involves a protrusion which can be turned down (completely turned) towards the outside.

One single part may include the lateral wall and each of the protrusions. Optionally the protrusion that can be turned down is of the type foldable between a position projecting upward relative to the level of the opening at a position turned down below the level of the opening. The protrusion that can be turned down may include a region forming a peelable attachment layer with which to form the sealing zone. Such region may extend for example midway between the upper end of the lateral wall and the gripping portion provided in the protrusion that can be turned down.

In various embodiments of the container according to the invention, one and/or another of the following provisions could further be used:
The bottom, the lateral walls and the protrusions are paper or cardboard based sheet materials, for example laminates comprising at least one paper or cardboard layer and possibly one or more layers of metal and/or plastic and/or other materials improving the barrier properties. The material in sheet form may have the form of coils or precut units.
The lateral wall is sleeved shape, such that the default positions of the two protrusions are positions of upward extension with a horizontal distance between them.
Each of the two protrusions has a base connected to the lateral wall, where the two bases form two halves of a periphery surrounding the opening of the container.
One of the two protrusions, preferably only one of the two protrusions, is connected to the lateral wall by a predetermined fold line, where a striation in the part (part forming the lateral wall and the two protrusions) serves to define a predetermined fold line.
The container is paper or cardboard based, preferably cardboard laminated and/or coated with a protective layer, for example hydrophobic, for a liquid barrier effect.
An overlapping zone (edge on edge) of the lateral wall is meant to be covered with a protective covering strap, preventing the liquid or aqueous substance from migrating towards an inner porous layer (fibrous layer, typically paper or cardboard) constituting the lateral wall.
The perimeter of the lateral wall increases with the distance relative to the bottom. (This arrangement serves to improve the accessibility of the product after opening the container.)
The two protrusions are a single unit with the lateral wall.
The lateral wall and the two protrusions are made in one piece, preferably a piece having the shape of a cutout of laminated or sheet material.
The part for forming the lateral wall and the protrusions is based on a deformable material including a cellulose material and conformed as a sleeve by overlapping two band portions.
The two band portions each include one lateral edge of the lateral wall, and are fixed to each other so as to form a liquid-tight barrier.
A gas-tight barrier effect may be achieved, in a junction zone/line for keeping an annular/tubular shape of the lateral wall), in particular by means of an outer coating over an overlapping zone of the two band portions.
At least one of the two protrusions is a protrusion that can be turned down towards the outside.
The opening is in part delimited by a fold line with which to turn down the foldable protrusion, preferably such that the foldable protrusion extends downward from the fold line.
The foldable protrusion is movable between a first position for closing the container and a second position; this second position is typically joined against the inner surface of the other of the two protrusions in the first position (where the foldable protrusion extends upward from a fold line parallel to the bottom), whereas in a second position, the container is open because of the folding of the foldable protrusion where this folding is done towards the outside opposite the other protrusion (which preferably continues to project upward).
The foldable protrusion includes an actuating part formed by one of the two gripping portions.
In the closed configuration, the actuating part of the foldable protrusion projects upward from/relative to an upper edge of the other protrusion, such that the actuating part is a free end part of the foldable protrusion.
The other protrusion comprises one of the gripping portions, which is offset relative to the actuating part, and axially projecting upward relative to an upper edge of the foldable protrusion, so as to form a free end part of the other protrusion.
Two actuating regions are typically formed in two offset gripping portions which are freely accessible by the top of the container (top of the container which may constitute means of closure/opening, in particular means of opening by pulling in order to open the container).
The means of opening the container may be flat in the flat closed configuration of the two protrusions.
In order to seal, an adhesive material may be added on at least one of the protrusions (on the inner zone), preferably on both protrusions, or an adhesive material can be incorporated for sealing at least one part of at least one of the protrusions. (This arrangement is preferably implemented for all of the sealing zone.)
The adhesion in the sealing zone is activated by simply bringing into contact and/or by specific action involving pressure and/or heating, for example thermal sealing; the adhesive material(s) are typically selected so as to be activatable.
The adhesion and the materials are such that the sealing is destroyed after opening (for example by making a re-closing in this sealing zone impossible; or the adhesion and the materials are such that sealing may be obtained again (with for example an adhesive material making the protrusions repositionable), as applicable less strong, after opening, when the container is resealable.
The sealing zone extends transversely to the central axis of the lateral wall which is tubular and/or flared.
The sealing zone extends between two opposite ends which, in the closed configuration and in an upright state of the lateral wall, are spaced horizontally from each other by a set distance greater than the largest characteristic dimension of the bottom (which extends horizontally).
The lateral wall is obtained from a cutout having two lateral edges which separate from each other while approaching the fold line which is typically horizontal.
The lateral wall may on its own define the height of the container.
In a flat configuration, the part forming the lateral wall and the protrusions is wider (between the two lateral edges) than high, whereas in the sleeve conformation, the lateral wall has a maximal width less than the total height of the container.
One end of the sealing zone may be adjacent to a first region of notches or interstices bordered on the bottom by the annular end and separating the two protrusions; the other end of the sealing zone may be adjacent to a second region of notches or interstices bordered on the bottom by the annular end and separating the two protrusions.
The interstices correspond to slots which may be offset from the sealing zone, optionally extending higher than the opposite ends of the sealing zone.
The sealing zone extends linearly or along two dimensions and defines a sealing plane.
The two protrusions are joined at least in part one on the other for extending in parallel to this sealing plane.
The bottom has an annular outer edge, for example circular, oval, polygonal, regular or not, with preferably rounded corners; for example triangular, square or rectangular, preferably with rounded summits or corners.
The shape of the bottom is noncircular.
The bottom is lengthened along a general direction, preferably horizontal, parallel to the sealing plane; in everything that follows, we speak of sealing plane when the protrusions extend upward, in a closed configuration of the container with access to the gripping portions from the top.
The bottom extends horizontally.
In the closed configuration of the container, the lateral wall below the opening level has a form (first geometric form) which is trapezoidal and expanding towards the opening, where this shape is perceived in frontal view relative to the sealing plane.
In the closed configuration of the container, the lateral wall below the level of the opening has a form (second geometric form) which is substantially triangular or conic frustum and expanding towards the bottom, where this shape is perceived in frontal view relative to the sealing plane.
The maximum horizontal extension of the first profile or first geometric shape may be greater than the maximum horizontal extension of the second profile or second geometric shape and, typically the minimal horizontal extension of the first shape (trapezoidal) is greater than the maximum horizontal extension of the second shape (where the horizontal dimension is of course understood considered in the upright state of the container, with the bottom wall on the bottom).
In front view relative to the sealing plane, the two protrusions narrow upward preferably by narrowing less progressively than the lateral wall.
In front view relative to the sealing plane, the angle of inclination relative to the vertical of each lateral edge of the protrusions (which may be a straight edge or not) may be greater than or equal to 30°, for example greater than or equal to 45°, whereas in longitudinal/vertical section view, the angle of inclination of the lateral wall relative to the vertical is smaller and typically included from 5 to 30°.
The two protrusions are connected to the lateral wall near an annular region defining a plane of the opening which is parallel to the bottom.
The two protrusions are the only two parts projecting relative to the annular end of the annular wall.
The two protrusions comprise or consist of one first ear, having an inner surface extending in the vertical extension of an inner surface of the lateral wall, and a second ear, having an inner surface extending in the vertical extension of the inner surface of the lateral wall.
The first and second ears are in contact against each other by the inner surfaces thereof in the closed configuration.
The at least one of the two protrusions narrow towards the top in the closed configuration by being delimited by two delimitation edges and having a gripping portion towards which the two delimitation edges converge.
One of the two protrusions, preferably only one of the two protrusions, is connected to the lateral wall by a predetermined fold line, where a striation in the part forming the lateral wall and the two protrusions serves to define a predetermined fold line.
The at least one of the two protrusions, which can be turned down towards the outside, has striations formed parallel to the opening.
The striations of a foldable protrusion each constitute one preset fold line, the set of these striations, which are parallel, assist and guide the folding outward and downward of the protrusion. (It is thus allowed to fold the protrusion quickly in a first step, without expanding the opening too much, and then in a second step, in the lowered state of the foldable protrusion, it is easy to expand the opening without unfolding the protrusion thus turned down.)
The foldable protrusion, in the open state of the container, extends downward from the fold line, for example by following along and being in contact with an outer surface of the lateral wall.
The fold line, with which the protrusion can be turned down, is for example a straight line in the closed state of the container (horizontal line); this fold line may possibly be curved, so as to increase the size of the opening in the open state of the container in the configuration where the foldable protrusion is turned down.
The bottom has one oval-shaped outer annular edge, so as to present a larger diameter or maximum diameter and a smaller diameter. (This arrangement also confers an increased stability compared to a circular bottom.)
The lateral wall is configured for expanding, by separation between the two protrusions in an open state of the container, where one dimension of the opening follows a direction of enlargement parallel to the direction of the smaller diameter.
The sealing zone has an inverted V shape and/or has locally at least one turned-back upper zone (or point); this arrangement serves to locally raise the sealing zone, in order to make the separation easier (separation by simple pulling of gripping portions separated from the upper end of the lateral wall and which can be integrated in the protrusions, all while allowing a hermetic closure).
The sealing zone is broken down into or includes one first adhesive band secured to and inseparable from one of the protrusions and one second adhesive band secured to and inseparable from the other of the protrusions, where the second adhesive band has one end overlapping the first adhesive band and where these two adhesive bands have for example different directions of extension.
The detachment of one protrusion from the other is allowed by the peelable nature of one or more self-adhesive layers provided in the sealing zone.
The container does not comprise a separable part. This feature avoids the user having to handle various parts, and avoids some parts being lost and/or not recycled. The opening is typically made without tearing, breaking or cutting the walls of the container.

According to the present invention, it is possible to propose a container which can be aesthetic, quick to open and capable of effectively preserving the content/product, as needed for fresh product to be consumed before warming up to ambient temperature. Further, significant flexibility in the geometry of the protrusions, which allow hermetically sealing, is permitted.

In one option, all or part of the sealing zone is part of a folded end of the container in a modified closed configuration. It can be provided that the two protrusions are in a folded state of a single lateral side of the container in the modified closed configuration. It is understood that this modification may consist in a simple folding with which to limit the vertical dimension of the container, which is advantageous for example during transportation or during presentation of the container on store racks or shelves.

An attachment element could be provided, for example an adhesive sticker serving to keep the modified configuration closed. The adhesive sticker is for example located on an attachment side and adhered laterally both on the lateral wall and on an end part of at least one of the gripping portions (after having turned down the two protrusions on the holding/attachment side).

According to another aspect, an assembly method is proposed for getting the container conforming to the invention, by axially delimiting the interior volume between the bottom delimiting a bottom of the container and an axial closure part covering the access opening from the top of the inner volume, where the process successively comprises the steps consisting essentially of:
supplying an initially flat part having two distinct protrusions or ears projecting relative to a part for forming a lateral wall of the container that results from cutting a material in sheet form;
tubularly conforming the part in order to get the lateral wall delimiting the interior volume;
connecting a bottom wall to a first end of the lateral wall in order to form the bottom, where the opening is located at a second end (forming the upper annular end of the lateral wall) opposite the first end, such that in the upright state of the container, the lateral wall extends vertically (or ascending only) from the bottom up to an annular end delimiting the opening;
filling the inner volume with product through the opening; and
hermetically closing the opening by bringing the two protrusions together and attaching them to each other, such that in a closed state of the container, the two protrusions are simultaneously projecting opposite the bottom, from an annular end of the lateral wall, and sealed to each other, preferably by the respective inner surfaces thereof, by forming a sealing zone with which to hermetically close the opening;
   and in which two gripping portions are distributed on the two protrusions, where each of the gripping portions is arranged outside of the sealing zone.

Because of this type of assembly, the container may be implemented with a minimum of recyclable parts (for example paper or cardboard) and an upper sealing is possible, at the stage of a final implementation step of the container which is easy to implement, without hindrance relating to the product which was poured in the inner volume (pouring of product without reaching or going past the level of the opening located below the sealing zone).

According to a specific feature, the first end of the lateral wall is conformed to an oval shape by attaching, by the interior, to an outer edge of the oval-shaped bottom.

Typically, the part is cut out and the lateral wall is conformed such that it has an increasing perimeter going away from the bottom. Optionally, the attachment between the two protrusions is done by forming the sealing zone transversely to a central axis of the lateral wall. Such a sealing zone may for example extend between two opposite ends which, in the closed configuration of the container and in an upright state of the lateral wall, are spaced horizontally from each other by a set distance greater than the largest characteristic dimension of the bottom (which extends horizontally).

The use of the container according to the invention is also proposed, in which, in order to open the container, the two protrusions are successively:
brought upright opposite the bottom in a closed configuration (closed configuration compatible with opening);
separated from each other by separating the two gripping portions until selectively lowering one of the two protrusions towards the outside;
   in that way, the container is opened by breaking a sealing junction made between the respective inner surfaces of the two protrusions without separating one or the other of the two protrusions from the lateral wall.

In that way a simple opening action results which may be compatible with a container of simple design, which could be compact to the extent where the sealing zone may be movable with the protrusions, which can for example be turned down. No breakage or tearing of wall material constituting the wall enveloping the product is required, nor is any breakage or tearing of any other end part covering all or part of the opening.

### BRIEF DESCRIPTION OF THE DRAWINGS

Other features and advantages of the invention will emerge from the description given below with reference to the attached drawings which show, as nonlimiting examples, embodiments and practicing of the subject matter of the invention. In these drawings:

FIG. 1 is a perspective view of a container before closing and, during a phase of filling with product, a portion of which must be knocked down in order to next allow the sealing of the opening of the container;

FIG. 2 is a frontal view of a container conforming to the invention, showing by transparency a possible location of a sealing zone, where FIG. 2 corresponds to a front view relative to a sealing plane;

FIG. 3 shows in a side view a container identical or similar to the one from FIG. 2 for which the upper projecting portions (ears or protrusions) are joined against each other while delimiting a sealing zone located above the fold line of one of the protrusions, where FIG. 3 corresponds to a side view relative to the sealing plane;

FIG. 4 shows a bottom example which can connect with a lateral wall of the container;

FIG. 5 shows an example of a part with which to form the lateral wall of the container, while it is flat before tubular shaping thereof, in an implementation example which calls for a junction line passing by one of the protrusions;

FIG. 6 is a view similar to that from FIG. 2 showing a container according to an embodiment of the invention;

FIG. 7 schematically shows an example of unfolding of the protrusion acting as a flap, with the possibility of deforming the transverse section of the lateral wall typically by enlarging the dimension of the opening of the container measured along a direction perpendicular to the fold line of the flap;

FIG. 8 is a logic diagram of steps with which, according to an embodiment, to manufacture a container conforming to the invention from a material in sheet form, based on laminated paper or cardboard.

FIG. 9A shows the steps of handling a container conforming to the invention in a closed state, in order to get the closed configuration such as that shown in FIGS. 2, 3 and 6 by starting from a nonoperational, modified closed configuration in order to allow opening and in which the two sealed protrusions are turned down.

FIG. 9B shows the handling steps allowed after having straightened up the protrusions of the containers shown in FIG. 9A in order to switch from the operational closed configuration to a stable open state in which to consume the product contained in the container.

### DETAILED DESCRIPTION OF THE INVENTION

In the various figures, the same numerical references designate analogous elements from the various embodiments shown and described.

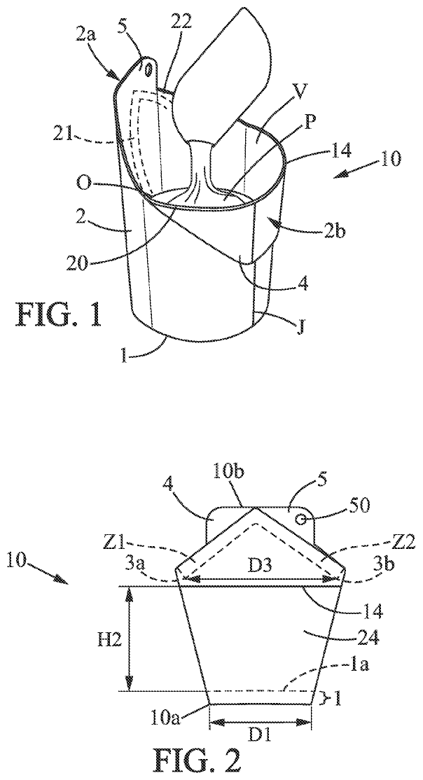

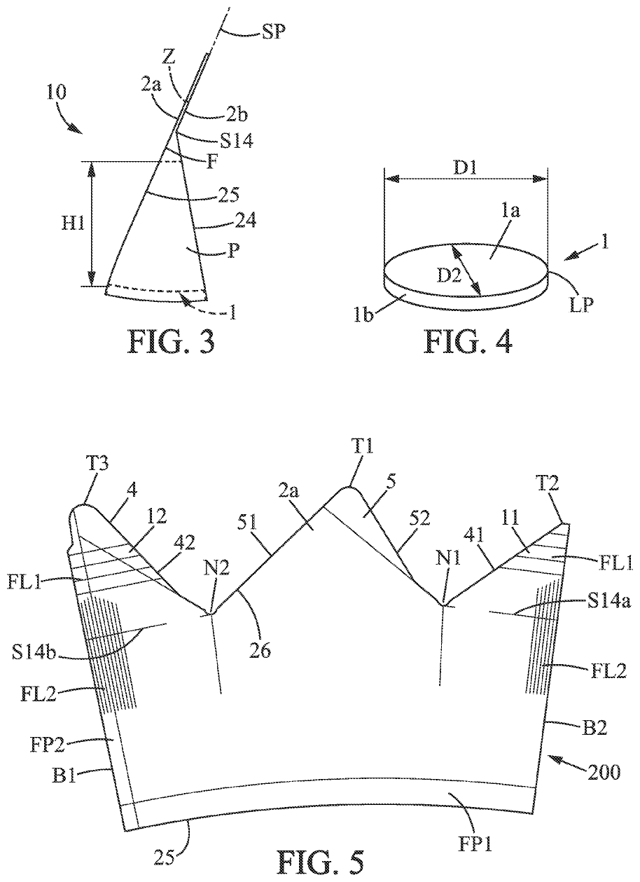

As shown in FIGS. 1, 2 and 3 the container 10 comprises a bottom wall 1 and is suited for delimiting an inside volume V above this bottom wall 1, while forming a lateral wall 2 connected (sealed) to the bottom wall 1. The container has an opening O, here a single opening which may be substantially as large as the bottom 1a of the container 10 (at least as large as a smaller dimension D2 of the bottom 1a, as applicable). The product P, for example a food product, may be poured into the inner volume V through such an opening O, before the sealing step which is done by bringing together two protrusions 2a, 2b which are typically formed as an integral part with the lateral wall 2. The sealing, obtained by an attachment of the two protrusions 2a, 2b against each other, serves to get the closed state of the container 10. The summit or top of this container 10 is thus of the type blocked without a separate cover, as seen in FIGS. 2 and 3.

The container 10 may be made from two parts each constituted of a material in sheet form: one for constituting the bottom wall 1, and the other for constituting the sidewall 2. In the implementation variants, the walls 1 and 2 may be made from a single part obtained by cutting of the material in sheet form. In other options, a larger number of parts may be used in order to get the recipient 10.

The bottom wall 1 is shaped so as to be undeformable and provide stability to the container 10 when it is in an upright state. As a nonlimiting example, as shown in FIG. 4, the part forming the bottom wall 1 may have a peripheral fold LP, corresponding to a junction line between:
a bottom 1a substantially flat and tended to be in contact with the product P; and
a tubular border 1b extending downward from the fold LP (annular fold line).

The fold LP is continuously curved and the bottom 1a may have a non-round section for example oval with a major diameter D1 larger than the minor diameter D2. The ratio D2:D1 may be less than or equal to 0.9. The outer surface of the tubular edge 1b may be fixed against an annular lower attachment zone of the lateral wall 2, called in the following first attachment part FP1. In FIG. 2, it can be seen that the lower end 10a of the container 10 may optionally extend lower than the bottom 1a. The top or upper end 10b of the container 10 may, in the closed configuration, include in the ends two protrusions 2a, 2b. In the open configuration, on the other hand, only one of the protrusions, here the protrusion 2a in the case of FIG. 1, remains upright projecting upward in order to form what remains of the upper end 10b. In other options, the upper end 10b may include just one of the protrusions 2a, 2b, with, in this case for example, a lateral arrangement of the projecting portion associated with the lower protrusion.

The lateral wall 2 is shaped like a tube, around a central axis X, and the two protrusions 2a, 2b consist of two ears projecting axially from the tube, therefore projecting relative to one annular end 20 of the lateral wall 2. The lateral wall 2 and the two protrusions 2a, 2b may be implemented here by one single piece 200 of the kind shown in FIG. 5 or the like. A laminated or sheet material may for example be cut in order to get a part 200 which is initially planar or flat before being shaped.

In the example shown, the part 200 is flexible, based on a deformable material and for example a cellulose type material. This cellulose material may optionally form over 90 or 95% of the average thickness of the container 10 (thickness which may correspond to the thickness of the lateral wall 2). The part 200 is cut laterally so as to include two lateral edges B1, B2. In the example shown, the two lateral edges B1, B2 diverge from each other as they get closer to a folding zone or fold line for the foldable protrusion 2b. This way the opening O can be enlarged for better accessibility to the product P.

In the option from FIG. 5, a fold line is provided which is obtained by the addition of two deformation lines or initial striations S14a and S14b serving to obtain a fold line 14 of the kind shown in FIG. 1. More generally, it can be provided that the lateral cut of the part 200 results in a profile of the perimeter of the lateral walls 2 (formed by this part 200), that increases going away from the bottom 1a. In other words, while getting closer to the annular end 20 of the annular wall 2, and thus to a fold line 14 serving to fold down at least one of the protrusions for the open configuration of the container 10, the section of the container 10 gets progressively larger.

This is advantageous for the actions for retrieving the product P by spoon, and also for reducing the height of the filling volume. In fact, such a height can be lowered compared to a lateral wall 2 having a constant perimeter, also making handling of the side of the bottom of the lateral wall 2 easier, where the perimeter is smaller and/or the stiffness is greater because of the connection to the wall element 1. Further, a shape flared downward is simpler to hold in just one hand for morphological reasons.

The first attachment part FP1 serves to stiffen a first end (lower) of the lateral wall 2, by attachment thereof against the folded or edged outer annular surface 1b of the bottom wall 1. In this way, the first end of the lateral wall 2 is stabilized and remains substantially constant/undeformed in section, without variation of geometry while changing from the closed configuration to the open configuration of the container 10. Conversely, the second end (upper) of the lateral wall 2 constitutes an annular end 20 of deformable section.

The second attachment part FP2, which may be extended along a longitudinal extension as shown in FIG. 5, serves to keep the tubular conformation of the lateral wall 2 while allowing a separation between the two protrusions 2a, 2b which is accompanied by a rounding of the top of the lateral wall 2 as seen from above. The attachment/overlap width corresponding to the second attachment part FP2 may be less than or equal to 10 mm, for example included between 3 and 8 mm. The second attachment part FP2 defines an outer attachment surface which is covered by a corresponding inner zone (from the rear side of the part 200 such as shown in FIG. 5 such that the lateral edge B1 and the associated lateral margin forming the attachment part FP2 will be hidden by the other lateral margin including the lateral edge B2. These lateral margins may be fixed to each other forming a liquid-tight barrier, for example by depositing an additional coating layer, after the attachment with the edge B2 covering over the edge B1.

To change from the flat conformation shown in FIG. 5, to the tubular conformation, the cut sheet or part 200 thus has a covered-over region, with an overlap of the opposite edges B1, B2 of the part 200. In that way a junction or junction line J results allowing the lateral wall 2 to form a tubular wall for delimiting the inner volume V. The bottom wall 1 could also be already joined by the inside against the first attachment part FP1 during shaping of the lateral wall 2.

Referring to FIG. 5, a single part 200 cut from a sheet may allow implementing the lateral wall 2, which extends from a lower edge 25 to an irregular upper cut edge 26. While the lower edge 25 can serve to define an annular section corresponding to a base plane of the container 10 at the lower end 10a thereof, in the tubular conformation of the part 200, the upper cut edge 26 includes two or three summits T1, T2, T3 which can be part of the gripping portions 4, 5.

In this example from FIG. 5, the fact of providing the junction line J near one of the protrusions 2a, 2b, for example a longitudinal junction line passing through one of the gripping portions (here the gripping portion 5), serves to extend the length of the attachment zone. Optionally, this junction line J corresponds to a maximum length of the lateral wall 2. This makes the container 10 more robust.

One of the two protrusions 2a, 2b, may be obtained by meeting of two protrusions 11, 12 initially formed in the part 200 at two opposite lateral ends, by having the summits T2 and T3 overlap and correspond/coincide, possibly at a single height. Here, a single gripping portion 4 may be obtained after having formed the junction line J (as can be seen on FIG. 1 for example). In this nonlimiting case, the gripping portion 4 is entirely included in the protrusion 12 and forms the summit T3 of the part 200 before assembly, where the summit T2 is not as high as the summit T3. In other words, the junction line J may stop before the gripping portion 4 or be offset relative to this gripping portion 4.

More generally various embodiments of the junction line J may be provided and the examples shown are only given for illustration. Even though shown with two straight edges B1, B2 cutouts that are wavy or have one or more hollow regions could be provided, without that preventing conforming the lateral wall 2 in the tubular manner.

Referring to FIG. 3, in the closed configuration of the container 10, the part of the container 10 formed by the part 200 might not have a zone folded at 90° or more along a horizontal hinge line or zone (parallel to the bottom 1a).

The container 10 may be suited for various capacities of product P, which can be a fresh food product, for example a dairy product (yogurt-based according to one option) and/or a compote, or as applicable a mixture of a solid product (like muesli, grains, chocolate chips, etc.) in a fluid or semi-fluid based product. The product P may be semiliquid, solid, or contain at least one liquid part. The product P is for example well suited for being consumed using a spoon and has a suitability for following the inner surface F of the lateral wall 2.

The inner surface F of the lateral wall 2 and the upper surface of the bottom wall 1 are contact surfaces made for example of a material and/or a film having a low permeability to water and approved for contact with food. Near the inner surfaces F1, F2 of the protrusions 2a, 2b, the material may be identical to that of the inner surface F, except possibly for an optional layer used to get the sealing zone Z or Z1, Z2.

On the outside, a material and/or a coating film may be provided which optionally is not inflammable.

Referring to FIGS. 3 and 4, the oval shape of the bottom 1a can make it easier to form the opposite panels 24, 25 constituting two main subparts of the lateral wall 2. FIG. 2 shows, in frontal view, one of these panels 24 (in frontal view relative to the sealing zone or sealing plane SP). In the closed configuration of the container 10, these panels 24, 25 are connected between them via narrow subparts each folded or curved inwards and extending vertically between the bottom wall 1 and the level of the opening O. Inside view of the container 10 as shown in FIG. 3, it can be seen that each narrow subpart (narrow compared to the width of the panels 24, 25) has a geometric shape which is substantially triangular or conic frustum broadening towards the bottom 1a. This shape is seen in side view relative to the sealing plane SP. The two narrow, opposite subparts are complementarity to the panels 24, 24 and therefore complete the panels 24, 25 in the lateral wall 2.

The panels 24, 25, visible in the closed configuration, can have an identical or similar geometry, possibly with a difference in inclination from vertical (more or less pronounced inclination, by forming an angle more or less close to 90° compared to the bottom 1a which is here horizontal). These panels 24, 25, such as seen in front view as in FIG. 2 for example for the panel 24, each has a contour or geometric shape which is trapezoidal, broadening towards the opening O.

Referring to FIG. 3, the level H1 for filling with product P may vary slightly downward when switching from a closed state of the container 10 to an open state. In fact, the sealing zone Z may be substantially flat (with an ascending/vertical component), by defining a sealing plane SP, which typically involves, in this example, a coplanar extension of the protrusions 2a and 2b, at least in part. This has the effect of making the two main panels 24, 25 converge towards each other in the closed configuration of the container 10, such that the fold line 14 separating the foldable protrusion 2b from the first panel 24 may be adjacent to the second panel 25 in the connection zone thereof with the protrusion 2a which extends towards the top of this panel 25. The effect of tightening between the panels 24, 25 pushes the product P upward (since this product P has a fluid or semifluid nature), to a height H1 which is above the level H1′ shown to the right in FIG. 7.

In fact, when the opening L was enlarged and the container 10 has a flared configuration/conformation even in side view (with the surface in the plane of opening extending past the surface of the bottom), as shown to the right in FIG. 7, the product P went back down a little. This flared configuration makes it easier to retrieve and consume the product P. These levels may satisfy the following relation: H1′<H1<H2

where H2 designates the height of the interior volume V, measured vertically from the bottom 1a up to the upper annular end 20 where the fold line 14 is formed.

Referring to FIGS. 1 and 7, the inner surface F1 of the protrusion 2a may include a self-adhesive layer or a contact attachment part, above the annular end 20 where the fold line 14 is defined. In the nonlimiting example from FIG. 1, this layer breaks down into two regions 21, 22 which rises towards the upper end 10b while meeting a junction part near the gripping portion 5. During detachment of the two portions 2a, 2b, which will be described in more detail later, this type of arrangement serves to initiate the detachment at the beginning of the handling for separation of the respective gripping portions 4, 5 associated with the protrusions 2a, 2b. In some implementation options, the attachment parts are distributed differently on the inner surfaces F1, F2 of the protrusions 2a, 2b. More generally, it is understood that the disposition of the sealing zone may be provided such that a region thereof is next to at least one other gripping portions 4, 5.

Referring to FIG. 2, it can be seen that the sealing zone Z1, Z2 extends entirely above the annular end 20 where the fold line 14 is defined. Here, the sealing zone Z1, Z2 has an inverted V shape broken down into a first sealing sub-zone Z1 and a second sealing sub-zone which meets the first sealing sub-zone Z2 for continuity of the sealed connection contact made by the sealing zone Z1, Z2. More specifically, the sealing zone may have any type of geometry for closing (here from the top) the opening O. It may be advantageous that the sealing zone Z locally has at least one turned-back upper zone (intermediate between two descending sealing parts) and ends 3a, 3b coming closest near the upper level of the product P, for example by reaching the level of the opening O. It is understood that in all cases, the sealing zone Z or Z1, Z2 extends transversely to a central axis X of the tubular lateral wall 2.

Typically, the sealing zone Z or Z1, Z2 extends continuously in the closed configuration between the two opposite ends 3a, 3b which are spaced horizontally from each other a fixed distance D3 greater than the largest characteristic dimension D1 of the bottom 1 as for example shown in FIG. 2.

### Material(s) of the Container

In the preferred embodiments, the container 10 comprises paper or similar fibrous material (preferably of natural origin) with which to form the body of the container 10 which delimits the inner volume V. The bottom wall 1 and the lateral wall 2 are, for example, implemented from a cardboard-based material having a reduced thickness, for example a thickness less than or equal to 2 mm, preferably strictly less than 1.5 mm. Each cardboard sheet may be obtained by being coextruded with some number of layers of plastic coating. Optionally, the multilayer structure (typically laminated structure) for one and/or the other among the bottom 1 and the lateral wall 2 comprises:
a layer of polyethylene;
a layer of cardboard;
a layer of polyethylene.

The polymer PLA or any other polymer well suited for hot welding or attachments may also be used in substitution for the polyethylene for at least one of the coating layers. In preferred embodiments, a junction edge of the lateral wall 2 present on the outer surface of this lateral wall 2 is covered with a plastic coating, for example deposited in the form of a jet/spray. This constitutes a protection for the overlapping band constituting the edge-to-edge junction J of the lateral wall 2 such as conformed in tubular fashion, knowing that this junction J is located in a deformable part of the container 10.

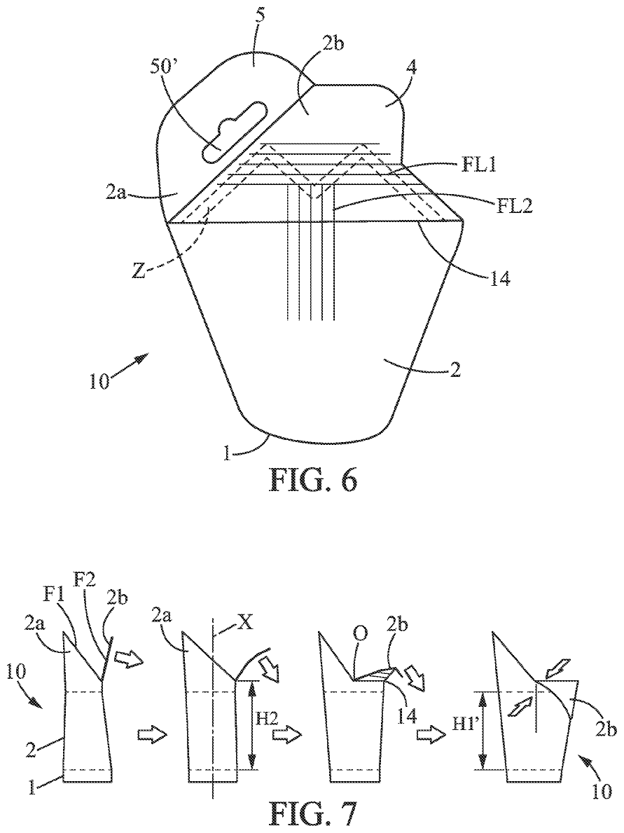

Referring to FIGS. 6 and 7, it is understood that the initially closed container 10 may be easily gripped respectively by the gripping portion 4 and the gripping portion 5, where the consumer pensions these portions 4 and 5 between that thumb and index finger and then separates the portions 4 and 5 so as to them that way separate the protrusions 2a and 2 in a side view relative to the sealing plane. FIG. 7 shows the possibility of changing the separation of the protrusions 2a, 2b during actuation, in particular by keeping the gripping portion 5 in an upright position (with the protrusion 2a here substantially vertical) while continuing to move the gripping portion 4 provided in the foldable protrusion 2b.

The material of the lateral walls 2 and the protrusions 2a, 2b is compatible with the formation of striations, resulting for example from local crushing of the fibrous and/or cellulose material incorporated in the thickness of this material. One or more sets of striations S14a, S14b, FL1, FL2, isolated striations or reliefs for assistance with the deformation and/or folding may make it easier to obtain, in the upper part of the lateral wall 2, a geometry suited to the consumption of the product P.

### Example of Integration of Fold Lines

At least in the foldable protrusion 2b, striations which each constitutes a set fold line may be provided. With reference to FIGS. 5 and 6, the striations are exclusively provided in one of the two subparts or panels constituting the two main opposite surfaces of the container 10 in the closed configuration thereof. An asymmetric property of the container 10 may also be obtained by placing horizontal striations exclusively on the panel 24 connected to the protrusion 2b to be turned down in order to free and expand the opening O. The striation S14 placed in the plane of the opening O thus forms the fold line 14. (This striation can result from the combination of several striations, for example the two striations S14a, S14b shown on FIG. 5.) The striation S14 may have a length substantially equal to a semi-perimeter of the annular end 20 bordering the opening O. Of course, any other local deformation or physical-chemical treatment step may be used in order to form a fold line with which to form a foldable protrusion 2b after a predetermined folding.

Other fold lines parallel to the fold line 14, already present in the closed configuration of the container 10, are optionally formed using striations FL1, which may be distributed on the foldable protrusion 2b, whereas the other protrusion 2a may be smooth and not have any fold lines. Typically it is intended that these fold lines, formed here by striations spaced at least 3 mm apart are shorter than the fold line 14, as can be seen in front view in the closed configuration.

Referring to FIG. 7, the fold of the flap formed by the protrusion 2b is formed by quickly swinging downward the corresponding gripping/actuating portion (gripping portion 4 from FIG. 6). By decomposing the movement of the protrusion 2b, which may be done in one second for example, inverting the orientation of the gripping portion 4 may be done before the protrusion 2b is turned down to over 45° around the fold line 14, which is possible with the help of the small fold lines FL1. The end of the range may then consist of pulling the protrusion 2b downward while continuing to fold and turn down towards the outside the lowest part of the protrusion 2b, until getting the fully turned down position visible in FIG. 1, typically without major enlargement of the opening O. In that way, assuming that the consumer uses their right hand for pulling the gripping portion 4, they may in a single gesture turn down the protrusion 2b. Next, by using their left-hand for gripping the recipient 10 by the periphery of the lateral wall 2 an additional action of pressure on the sides by their left-hand, exerting a pressure as shown on the right of FIG. 7 by the two arrows in opposing directions, is sufficient for enlarging the opening O by further separating the respective bases of the protrusions 2a and 2b.

More generally, it is understood that the set of these striations 14, FL1, which are parallel, assists and guides the folding outward and downward of the protrusion 2b. In that way the protrusion 2b can be turned down quickly in a first step, without expanding the opening O too much. And then in the second step, in the state with the foldable protrusion lowered, it is easy to expand the opening O without unfolding the protrusion 2b which thus remains turned down. in other words, the presence of a series of striations FL1, for example at least three parallel striations, serves to promote the action of folding down instead of the action of expanding the opening O, when the protrusions 2a, 2b are separated from each other by traction in opposite directions near the gripping portions 4, 5.

In some options, forming striations FL2 or similar reliefs with vertical extension, as seen in particular in FIGS. 5 and 6, is provided, for example asymmetrically and only on the panel 24, from the same side as the foldable protrusion 2b. The striations FL2 may extend vertically on either side of the fold line 14 and contribute to assisting/helping the end of range in the folding movement of the protrusion 2b, for example by avoiding the formation of angle(s) blocking the movement of the flap.

In practice, these striations FL2 (here at least five or six) may provide a guiding effect, in order to more easily around the lateral wall 2 and by avoiding the formation of a pronounced angle or V-shaped profile which would be visible in top view. The rounding of fold line 14 may then be close or identical to the illustration from FIG. 1 while avoiding forming a pronounced angle near the junction line J.

In some embodiments of the side of the panel 25 where no fold, start of fold or striation is provided (with the protrusion 2a not being turned down), a smooth surface results on which printing can be done. More generally, any type of marking (possibly embossing) can be done on the surface that has no fold line, since such a surface is favorable to the visibility of information, for example information about the product P contained in the inner volume V. The flattened appearance of the panel 25 further makes reading such information easy for consumers looking at the container 10 in a stored condition on a shelf in a store or an analogous display situation.

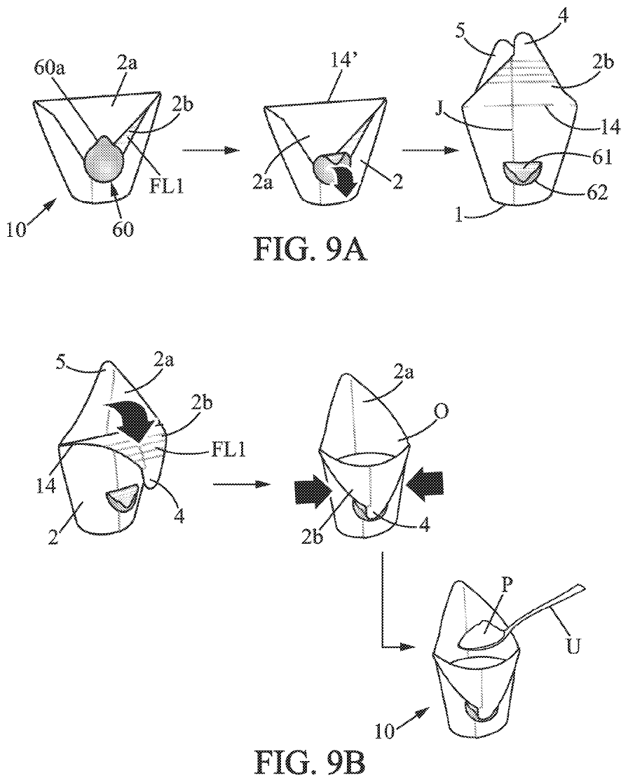

FIGS. 9A and 9B show the way in which the container 10 may be handled, while changing from a compact configuration to a deployed configuration, and then to an open configuration that allows consumption of the product P contained in the inner volume V of the lateral wall 2. Fold lines FL1 may also be provided in this embodiment in order to make folding of the protrusion 2b with an arc-shaped conformation (bulging outward) compatible with a large opening O of the container 10. It involves an optional embodiment.

As can be seen in FIG. 9A, the two protrusions 2a, 2b may be turned down on the same side against the outer surface of the lateral wall 2, in a modified closed configuration with all or part of the sealing zone turned down (in order to extend below the level of an exterior fold line 14′ here provided on the protrusion 2a. It is understood that this configuration limits the height dimension of the container 10.

More generally, all or part of the sealing zone may be mobile in the sealed state of the two protrusions 2a, 2b, in particular when the height of the container 10 is to be minimized during steps of transportation and/or storage. In other words, container 10 has a mobile end (mobile by pivoting or folding along the line 14′) in order to be turned down in a modified closed configuration. As shown in FIG. 9A, the user may release and/or grip the mobile end of the container 10 to straighten it up, in order to change from the modified closed configuration to the closed configuration such as shown in FIGS. 2, 3 and 6. In the modified closed configurations, the gripping portions 4, 5 are turned down with the protrusions 2a, 2b and thus protected from a motion of accidental opening. An attachment element could be provided, for example an adhesive sticker 60 serving to maintain the modified closed configuration. The adhesive sticker 60 is for example located on an attachment side and adhered laterally both on the lateral wall 2 and on an end part of the container including at least one of the gripping portions, here the gripping portion 5 of the protrusion 2a.

The adhesive sticker 60 comprises a tab 60a or an analogous pull constituting a gripping portion for detaching a part of this sticker and folding it downward. In practice, after having detached this upper part of the adhesive sticker 60, the user releases the mobile end which can straighten out upward. In this way, the gripping portions 4 and 5 may have an operational configuration allowing the opening of the container 10. In this nonlimiting example, these gripping portions 4 and 5 extend upward relative to the remainder of the corresponding protrusions 2a and 2b, which correspond to the deployed closed configuration. More generally, it is understood that in the deployed closed configuration allowing operation of the opening, the foldable protrusion 2b is found in position projecting upward, from the fold line 14.

Referring now to FIG. 9B, the foldable protrusion 2b may be folded outward and come into contact with the part of the adhesive surface of the sticker 60. In fact, since this part of the adhesive surface 61 was turned over towards the outside, it constitutes a support for attaching/holding the protrusion 2b in turned down position. In the example shown, the gripping portion 4 comes into contact against the adhesive surface 61. It should be underlined that this embodiment avoids entirely detaching the sticker 60, so that it does not constitute a separate part that could be lost. in fact, a fixed part 62, belonging to the sticker 60, that is not detached from the lateral wall 2 remains behind.

The sticker 60 can be adhered with two different adhesion forces: stronger for the part 62 which is fixed and weaker for the part 61 which can be peeled. The sticker 60 is made as a single part and may consist of a multilayer sheet material, preferably without metal layer.

Obtaining a large opening O is typically obtained in the same way already described with reference, for example, to FIG. 7. An inward pressure by the user on the lateral wall 2, on both sides of the turned-down protrusion 2b serves to expand the section of the opening O without also raising the flap formed by the protrusion 2b. The product P can then be easily consumed, for example by a utensil U such as a spoon, fork, or other suitable utensil(s).

### Implementation Options for the Gripping Portions

In the embodiment shown, the gripping portions 4, 5 are asymmetric and one of them has an opening 50, 50′ making it easier to support the container on store shelves or racks. The gripping portions 4, 5 are typically incorporated in the protrusions 2a, 2b, without folding or changing direction, by projecting upward/extending higher respectively relative to an opposite edge of the other protrusion 2a or 2b. The upper end of the container 10 may then include these two gripping portions 4, 5 in the closed state. In that way, the gripping portions 4, 5 may be aligned in the plain SP which includes the sealing zone Z; Z1, Z2.

Alternatively, various shapes, symmetric or asymmetric, may be provided for the gripping portions 4, 5. For example, at least one of the gripping portions 4, 5 may reach the upper end of the container 10 in the closed state and/or may form a tab placed outside of the sealing plane SP.

Each gripping portion may extend, vertically or at an angle, from a baseline to a free upper end. Each baseline of the gripping portion 4 or 5 is then aligned with an edge for delimiting the other protrusion, delimitation edge beyond which the gripping portion 4 or 5 considered extends. Typically this base line is lengthened and extends 25 or 30 mm past for each of the protrusions 4, 5 which makes these protrusions robust and easy to grip. They are optionally made from laminated cardboard or analogous cellulose material that is sufficiently compressed and/or protected by a coating in order to resist tearing such that they are in practice impossible to tear accidentally.

Referring to FIG. 5, the protrusions 2a, 2b may each—or at least one of them—narrow towards the top in the closed configuration by being delimited by two delimiting edges 41, 42 or 51, 52. It is understood that this gripping portion 4, 5 may correspond to a region of the protrusion towards which the two delimitation edges 41, 42, or respectively 51, 52, converge.

### Example of Manufacturing Process

Referring now to FIGS. 4, 5 and 8, a nonlimiting example of manufacturing a container 10 by using material in sheets such as laminated cardboard is described.

The part 200 shown in FIG. 5 may be obtained after several steps including one or more steps of cutting and processing steps with which to define the fold line 14 for folding the second foldable protrusion 2b and also other fold lines and/or weakening of material.

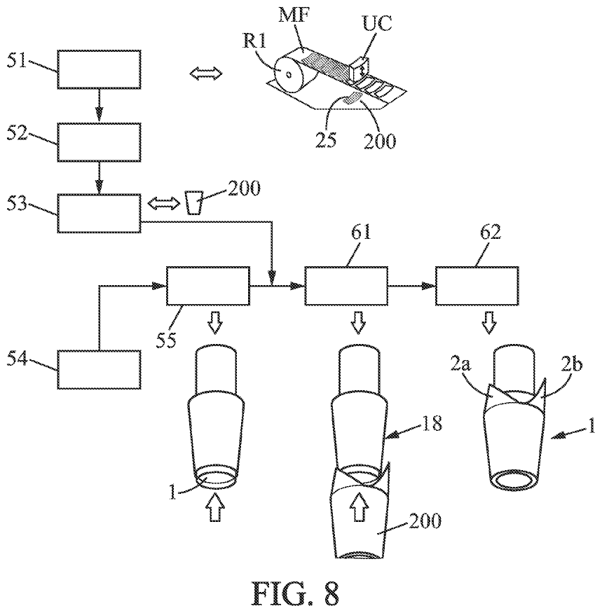

As can be seen in FIG. 8, a roll R1 made up of the material in sheet form having a suitable multilayer structure (such as described above, for example PE/cardboard/PE) may be unwound. A cutting step 51 is done, optionally at high speed, by a cutting tool UC in order to get pieces of sheet, here with trapezoidal shape. It is understood that the part 200 may result from the cutting done just once or possibly broken down into an initial cut and a secondary cut of a piece from a material in sheet form MF. In the example shown, for simplification, the protrusions have been omitted in the cutting step 51. However, it may be preferred to make the contour of the two protrusions 2a, 2b once this initial cut is done at step 51. In other words, this cut serves to define the final lower edge 25, the two sides or lateral edges B1, B2 (in a general shape which is then close to a trapeze) and also the two protrusions 2a, 2b. The part 200 thus results. As shown in FIG. 5, two lateral edges B1, B2 are provided which separate from each other going away from the lower edge 25 and approaching near the opening O. This type of geometry of the lateral edges B1, B2 is advantageous for providing an increased deformation effect near the opening O.

Each part 200 then undergoes a series of treatments for shaping. For example, the band portions formed in the lateral margins of each piece (margins including the edges B1, B2) can be directly heated and then the part 200 conformed as a sleeve. A turning mold with conic frustum geometry may form a support so that the part 200 can be wound around this mold, such that they form a sleeve because of the overlap of the lateral margins or band portions. This shaping step 52 may optionally combine heating and winding of the part 200.

Typically, an edge protection step 53 is implemented in order to cover up the edge(s) B1, B2 which are involved in forming the junction part J, with a coating which improves the tightness against liquids. In this way, the junction part J of the lateral wall 2 is durably sealed (considering the length of transportation/storage in the store and at the consumer, especially if it involves a product to be stored fresh in a refrigerator). At the outcome of step 52 of shaping and this optional step 53, the part 200 is in its final conformation and already forms the lateral wall 2 provided with protrusions 2a, 2b, without however being connected to the wall of the bottom 1.

Then, a striation S41 or similar weakening may be implemented in order to form the fold line 14 before the shaping step 52. In the same way, the groups of horizontal striations FL1 in the protrusion 2b and/or striations FL2 with vertical component on either side of the striation S14 may be made before the step 52, respectively by pressure from at least one molding/relief member.

The opening 50, 50′, shown as formed in one of the protrusions 2a, 2b, here in the gripping part 5 of the protrusions 2a in the nonlimiting example from FIGS. 2 and 6, may also be pierced by a hole before the shaping step 52. This type of orifice 50, 50′ may make it easier to display and/or gather (for example in a row) a set of containers connected by a string, hoop, carabiner or similar connecting element passing through each opening of the containers from the same set. Possibly, a bag of a content which can be associated with the product P in the container may accompany the container 10 by being attached to the string, hoop, carabiner or similar connecting element.

In parallel with the production of the parts 200 forming the lateral walls 2, bottom walls 1 are also designed from a laminated material coil, preferably comprising a paper or cardboard layer, for example the same material as the lateral wall 2. After cutting step 54, which may use similar equipment to that of step 51, apart from the type of contour cut (which may be an oval cut), a step 55 of shaping is implemented in order to fold the peripheral annular region of the corresponding part, so as to get the peripheral fold LP and create the border 1b, here surrounding an assembly member 18 with conic frustum mold.

The connection between the wall elements 1 and 2 is implemented for example by step 61 of positioning with overlap of the attachment part FP1 on the border 1b, at the outcome of which the lateral wall 2 is held in a set position fixed relative to the bottom wall 1. FIG. 8 shows the last step 62 consisting of a hot attachment of the bottom wall 1. The container 10, ready to be filled, may then be obtained by heating and possibly by a pressure treatment, serving to attach and seal the outer surface of the border 1b to the inside of the attachment part FP1.

In some options, one or more treatments for sealing may be implemented during the step 62 or after the step 62. For example, the junction J may be sealed in an assembled state of the walls 1 and 2.

The filling, such as shown in FIG. 1, using any type of system for pouring doses of product P, may be done next, before the final step of closure by implementing the sealing zone Z or Z1, Z2.

It must be obvious for the people skilled in the art that the present invention allows embodiments under many other specific forms without going outside the scope of application of the invention as claimed.

Thus, although the figures show a container 10 whose lateral wall 2 is made in a single piece, a lateral wall including two related parts may be provided. All sorts of elements making holding easier, in particular one or more textured surfaces, ribs or other comparable surface features may also be inserted in the lateral wall 2, only on the side of the protrusion 2b, or elsewhere. For some uses, a ring (possibly with elastic restoring force) or a sleeve may be provided, for example configured for surrounding an upper part of the outer surface of the lateral wall 2. A stiff cup with section comparable to the section of the opening O of the container 10 and an open state may also form a support for the container 10. Such a ring or cup, reusable, serves for example to more easily shift the transverse section of the upper end of the lateral wall 2 from an elongated oval shape (elongated in the direction of the respective interstices N1, N2 formed between the two protrusions 2a, 2b) to a substantially circular shape which can make the consumption of the product P easier, as applicable with a spoon. The ring or cup may serve to get the conformation shown on the right of FIG. 7, typically after having turned down the protrusion 2b.

Further, although filling from the top is preferred as shown in FIG. 1, filling with product P may be done in various ways, possibly by the bottom before implementing a step of final closure by the bottom in some variants, where the filling may then be done opposite from the opening O intended for retrieving/consuming the product P.

1. A container, intended for packaging a product, comprising:
a bottom;
a lateral wall delimiting an interior volume, where the lateral wall extending upward from the bottom up to an annular end delimiting an opening for access to the interior volume;
wherein the container has a closed configuration and further comprises two distinct protrusions in order to get the closed configuration,
wherein the two protrusions are simultaneously:
projecting opposite the bottom, from the annular end of the lateral wall; and
sealed to each other so as to form a sealing zone in order to hermetically close said opening;
wherein the container has two gripping portions, distributed on the two protrusions, each of the gripping portions being arranged outside of the sealing zone.

2. The container according to claim 1, wherein the two gripping portions are offset from each other.

3. The container according to claim 1, wherein at least one of the two protrusions is a protrusion comprising an external flap folded out outwards.

4. The container according to claim 1, wherein at least one of the two protrusions is a protrusion that can be turned down towards the outside of the container,
and wherein the opening is in part delimited by a fold line with which to turn down said foldable protrusion, such that the foldable protrusion extends downward from the fold line.

5. The container according to claim 4, wherein the foldable protrusion, is movable between:
a first position for closing the container by being joined against inner surface of the other of the two protrusions, where the foldable protrusion extends upward from the fold line which is parallel to the bottom; and
a second position, wherein the container is open because of the folding of the foldable protrusion, where the folding of the foldable protrusion is done towards the outside of the container, opposite the other protrusion, which continues to project upward.

6. The container according to claim 4, wherein the foldable protrusion includes an actuating part formed by one of the two gripping portions, and wherein in the closed configuration, the actuating part projects upward from an upper edge of the other protrusion, such that the actuating part is a free end part of the foldable protrusion.

7. The container according to claim 6, wherein the other protrusion comprises one of the gripping portions, which is:
offset relative to the actuating part;
axially projecting upward relative to an upper edge of the foldable protrusion, so as to form a free end part of the other protrusion.

8. The container according to claim 1, wherein the sealing zone extends transversely to a central axis of the tubular lateral wall; where the sealing zone extends between two opposite ends which, in the closed configuration and in an upright state of the lateral wall, are spaced horizontally from each other by a set distance greater than the largest characteristic dimension of the bottom which extends horizontally.

9. The container according to claim 1, wherein the lateral wall and the two protrusions are made in one piece, which is a cutout of laminated or sheet material.

10. The container according to claim 1, wherein the lateral wall and the two protrusions are made in one piece;
and wherein one of the two protrusions is connected to the lateral wall by a predetermined fold line, where a striation in said part serves to define the predetermined fold line.

11. The container according to claim 9, wherein said piece is made of a deformable material including a cellulose material and conformed as a sleeve by overlapping two band portions which:
each includes one lateral edge of the lateral wall; and
are fixed to each other so as to form a liquid-tight barrier.

12. The container according to claim 1, wherein the sealing zone extends linearly or along two dimensions and defines a sealing plane, where the two protrusions are joined at least in part one on the other for extending in parallel to the sealing plane.

13. The container according to claim 1, wherein the lateral wall has a circumference, forming a varying lateral wall perimeter, which increases with distance relative to the bottom.

14. The container according to claim 1, wherein the at least one of the two protrusions is tapering towards the top in the closed configuration by being delimited by two delimitation edges and having a gripping portion, which is one among said two gripping portions, towards which the two delimitation edges converge.

15. The container according to claim 1, wherein the at least one of the two protrusions, which is configured to be turned down towards the outside of the container, has striations formed parallel to the opening.

16. The container according to claim 1, wherein the bottom has an oval-shaped outer annular edge, so as to present a larger bottom diameter and a smaller bottom diameter,
wherein the lateral wall is configured for expanding, by separation between the two protrusions in an open state of the container, a dimension of the opening along an enlargement direction parallel to the direction of the smaller bottom diameter.

17. The container according to claim 1, wherein the sealing zone comprises an inverted V shape.

18. The container according to claim 1, wherein all or part of the sealing zone is part of a folded end of the container in a modified closed configuration,
and wherein the two protrusions are in a folded state, folded in a same lateral side of the container, in the modified closed configuration.

19. An assembly method for obtaining the container according to claim 1 by axially delimiting the interior volume of the lateral wall (2) between a bottom delimiting a bottom of the container and an axial closure part covering a top access opening of the interior volume,
wherein the method successively comprises:
supplying an initially flat piece, having two distinct protrusions or ears projecting relative to a part for forming a lateral wall of the container, that results from cutting a material in sheet form;
annularly conforming the piece in order to get the lateral wall delimiting the interior volume;
connecting a bottom wall to a first end of the lateral wall in order to form the bottom, where the top access opening is located at a second end of the lateral wall, of annular shape, opposite the first end, such that in the upright state of the container, the lateral wall extends ascending from the bottom up to an annular region delimiting the top access opening;
filling the interior volume with product through the top access opening; and
hermetically closing the top access opening by bringing the two protrusions together and attaching them to each other, such that in closed state of the container, the two protrusions are simultaneously projecting opposite the bottom, from the second end of the lateral wall, and sealed to each other by forming a sealing zone with which to hermetically close the top access opening;
and wherein two gripping portions are distributed on the two protrusions, each of the gripping portions being arranged outside of the sealing zone.

20. The container according to claim 1, wherein the container is configured to be open by handling of the two protrusions, which are successively:
brought upright opposite the bottom in the closed configuration;
separated from each other by separating the two gripping portions until selectively lowering one of the two protrusions towards the outside of the container;
the container being directly opened by breaking a sealing junction made between respective inner surfaces of the two protrusions without separating one or the other of the two protrusions from the lateral wall.
